(19) United States
(12) Patent Application Publication
(10) Pub. No.: US 2009/0217486 A1
(43) Pub. Date: Sep. 3, 2009

(54) HINGE DEVICE AND ELECTRONIC APPARATUS

(75) Inventors: Hiroaki Itakura, Ome-shi (JP); Yuji Nakajima, Mizuho-cho (JP); Shinji Hiratomo, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/275,081

(22) Filed: Nov. 20, 2008

(30) Foreign Application Priority Data
Feb. 28, 2008 (JP) 2008-048648

(51) Int. Cl. E05D 11/10

(52) U.S. Cl. 16/334; 16/321

(57) ABSTRACT

According to one embodiment, a hinge device includes: a first bracket; a first cam member; a second cam member; a disc spring that urges the second cam member; a first friction plate provided correspondingly to the first bracket, the first friction plate disposed oppositely to the first cam member with respect to the first bracket; a stopper member provided correspondingly to the first friction plate on one side thereof, the stopper member disposed oppositely to the first bracket with respect to the first friction plate, the stopper member engaged with the first bracket; and a hinge shaft having a shaft that rotatably supports the first bracket, the first cam member, the disc spring, and the stopper member, and that unrotatably supports the second cam member and the first friction plate.

### CROSS-REFERENCE TO RELATED APPLICATIONS

This application is based upon and claims the benefit of priority from Japanese Patent Application No. 2008-048648, filed on Feb. 28, 2008, the entire contents of which are incorporated herein by reference.

### BACKGROUND

1. Field

One embodiment of the invention relates to a hinge device and an electronic apparatus, and more particularly to a hinge device having a mechanism for increasing the torque.

2. Description of the Related Art

Conventionally, an electronic apparatus such as a portable computer, is configured of a main body unit having a keyboard, and a display unit including a liquid crystal display. The display unit is rotatably supported by a hinge device on the main body unit.

The hinge device has a first bracket, a second bracket and a hinge shaft. One end of the hinge shaft is rotatably supported on the first bracket, and the other end of the hinge shaft is fixed to the second bracket. Therefore, the first bracket and the second bracket can be relatively rotated around the axis of the hinge shaft.

In recent years, as a liquid crystal display device of larger size is favorable, the display unit of the portable computer also tends to be larger in size. Accordingly, the hinge device is required to produce a larger rotational torque along with the larger size of the display device.

JP-A-2005-76790 (see page 10, FIG. 3) discloses a technique for increasing the rotational resistance by providing a rotational resistance increasing elastic portion formed of a leaf spring between a relative rotation portion and a second mounting portion like a case relatively rotated around a rotational shaft portion.

However, the leaf spring of JP-A-2005-76790 has necessarily the shape incorporated into the second mounting portion, whereby the shape of the leaf spring itself is complicated. Accordingly, there may be a problem that the hinge device has a complex constitution as a whole.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of the portable computer according to an embodiment of the present invention;

FIG. 2 is an exemplary perspective view, partially broken away, of the portable computer;

FIG. 3 is an exemplary perspective view showing a hinge device 21;

FIG. 4 is an exemplary perspective view showing the hinge device 21;

FIG. 5 is an exemplary exploded view showing the hinge device 21;

FIG. 6 is an exemplary exploded view showing the hinge device 21.

FIGS. 7A and 7B are exemplary views showing a state where a display unit 3 is closed on the main body unit 2;

FIGS. 8A and 8B are exemplary views showing a state where the display unit 3 is opened up to 90° with respect to the main body unit 2;

FIGS. 9A and 9B are exemplary views showing a state where the display unit 3 is opened up to 135° with respect to the main body unit 2; and

FIG. 10 is an exemplary perspective view showing a hinge shaft 230.

### DETAILED DESCRIPTION

Various embodiments according to the invention will be described hereinafter with reference to the accompanying drawings. In general, according to one embodiment of the invention, there is provided a hinge device including: a first bracket; a first cam member having a first cam face at one side, wherein the other side engages with the first bracket; a second cam member having a second cam face at one side, the second cam face provided correspondingly to the first cam face; a disc spring that urges the second cam member on the other side thereof, which is opposite to the second cam face; a first friction plate provided correspondingly to the first bracket, the first friction plate disposed oppositely to the first cam member with respect to the first bracket; a stopper member provided correspondingly to the first friction plate on one side thereof, the stopper member disposed oppositely to the first bracket with respect to the first friction plate, the stopper member engaged with the first bracket; and a hinge shaft having a shaft that rotatably supports the first bracket, the first cam member, the disc spring, and the stopper member, and that unrotatably supports the second cam member and the first friction plate.

### Embodiment of the Invention

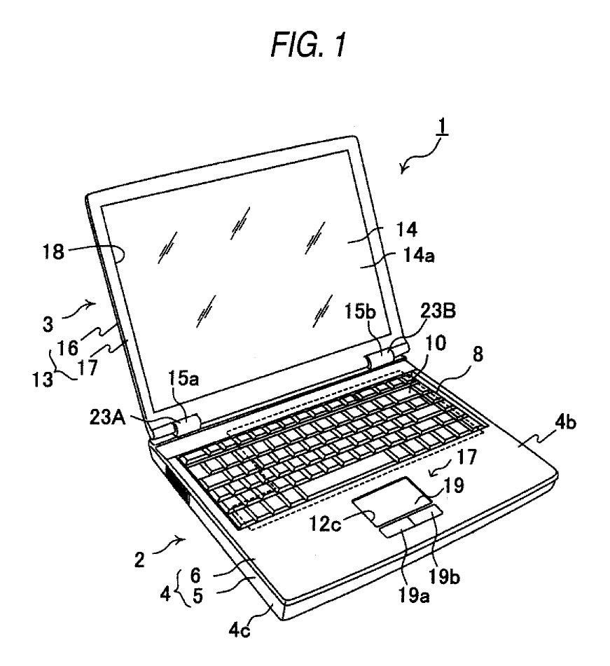

The embodiment of the present invention will be described below with reference to the drawings in connection with a portable computer. FIG. 1 shows a portable computer 1 as an electronic apparatus. This portable computer 1 is configured of a main body unit 2 and a display unit 3.

The main body unit 2 has a first casing 4 made of resin. This first casing 4 has a base 5 and a top cover 6, and is formed in the shape of a flat box.

An outer face of the top cover 6 exposed outside has an upper wall 4b and a side wall 4c. At a back end portion of the top cover 6, a pair of leg portions 15a and 15b are spaced in the width direction of the first casing 4.

The display unit 3 includes a liquid crystal display portion 14 having a second casing 13 and a screen 14a received within the second casing 13. The second casing 13 is composed of an LCD cover 16 and an LCD mask 17, and an opening portion 18 for display is provided on a front wall of the LCD mask 17. This opening portion 18 has a size extending over most part of the front wall, and the screen 14a of the liquid crystal display portion 14 is exposed outward of the display unit 3 through this opening portion 18.

The first casing 4 includes a keyboard mounting portion 8 and a touch pad 19. The keyboard mounting portion 8 is a rectangular recess portion opening to the upper face of the upper wall 4b, and bears a keyboard 10. The touch pad 19 is provided to be exposed through an opening portion 12c located in front of the keyboard 10 on the upper wall 4b of the top cover 6, and has switches 19a and 19b.

The display unit 3 has a pair of connecting concave portions 23A and 23B at one end portion thereof. Each of the connecting concave portions 23A and 23B is composed of a concavity that opens forward, downward and backward of the display unit 3. The connecting concave portions 23A and 23B are spaced in the width direction of the display unit 3, and led to the leg portions 15a and 15b of the first casing 4. And these connecting concave portions 23A and 23B are rotatably supported by the hinge devices 21 and 22 at the back end portion of the first casing 4, as will be described later.

Therefore, the display unit 3 can be rotated between a closed position where it is flattened to cover the upper wall 4ba and the keyboard 10 from above and an open position where it is raised to expose the upper wall 4b and the keyboard 10. In FIG. 1, it should be noted that the computer 1 is illustrated in the open position.

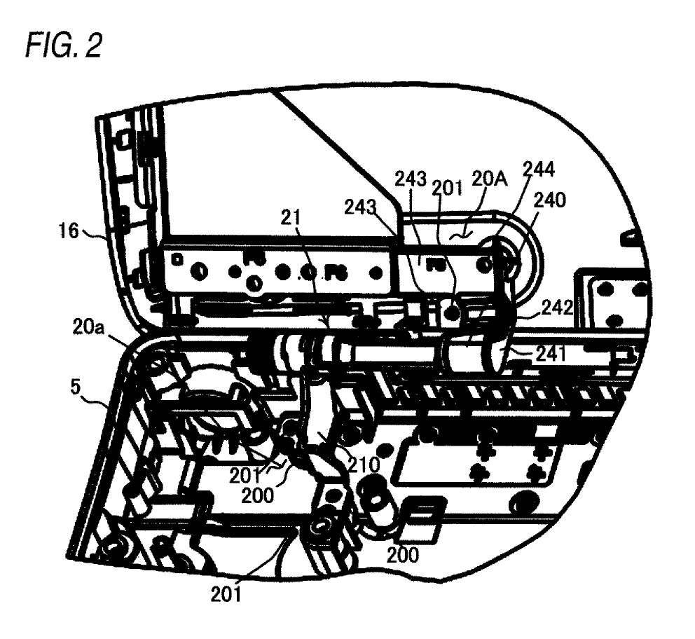

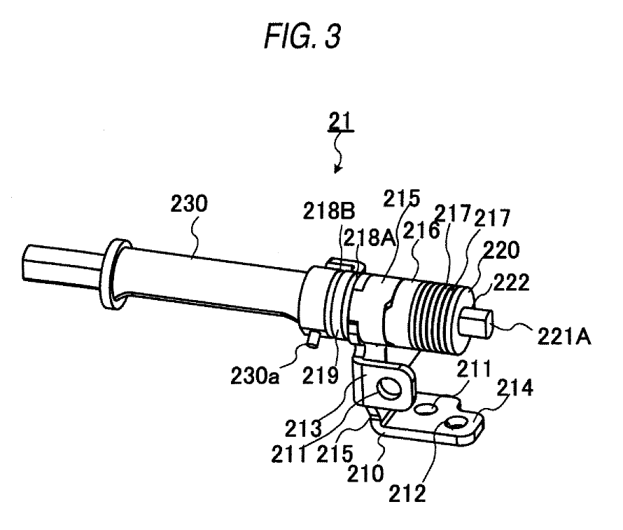

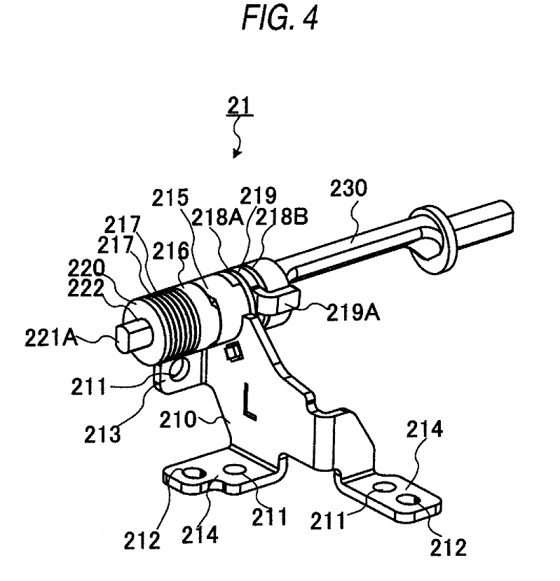

FIG. 2 is a perspective view, partially broken away, of the portable computer according to the embodiment of the invention. FIGS. 3 and 4 are perspective views showing the hinge device 21.

The base 5 of the first casing 4 has a pair of hinge support portions 20a and 20b in the areas for supporting the first hinge device 21 and the second hinge device 22. In FIG. 2, a hinge support portion 20a is only illustrated. A basic structure around the hinge is almost equivalent for both the hinge support portions 20a and 20b, because they are disposed in bilateral symmetry. In the following, the hinge support portion 20a is only explained, and the hinge support portion 20b is not explained except for specific cases.

The hinge support portion 20a rotatably supports the base 5 and the LCD cover 16 by the first hinge device 21 made of metal, fastened by a screw 23 (not shown). The hinge support portion 20a has a screw fixing portion 200 and a positioning portion 201.

The first hinge device 21 has a first bracket 210 fastened by a screw to the hinge support portion 20a of the base 5, and the first bracket 210 has a screw through hole 211 for passing the screw 23 and a positioning hole 212, as shown in FIGS. 3 and 4.

The hinge device 21 is provided to link between the base 5 and the LCD cover 16, as shown in FIG. 2. More specifically, the first bracket 210 of the hinge device 21 is fixed to the hinge support portion 20a in the base 5. The hinge device 21 is fastened to the screw fixing portion 200 of the base 5 by the screw inserted through the screw through hole 211 of the first bracket 210 (the screw is not shown). The positioning portion 201 is inserted into the positioning hole 212 of the first bracket 210 to position the first bracket 210.

On the other hand, a second bracket 240 of the hinge device 21 is fixed to a hinge support portion 20A in the LCD cover 16. The second bracket 240 is fixed to the first hinge device 21, and connected with the LCD cover 16 by a screw, as shown in FIG. 2. Herein, the hinge support portion 20A is an area for supporting the first hinge device 21, and located in an area opposed to the hinge support portion 20a or in the neighborhood of the opposed area, when the display unit 3 is in the closed position. This positional relation depends on the shaft length of a hinge shaft 230.

The hinge support portion 20A has the screw fixing portion 200 and the positioning portion 201. In FIG. 2, the screw fixing portion 200 in the hinge support portion 20A is not shown.

The second bracket 240 has a shaft fixing portion 241 fixed to the hinge shaft 230, an arm 242 integrated with the shaft fixing portion 241, an LCD cover fixing piece 243 provided at the top end of the arm 242, and a screw through hole 244 for passing a screw fixing the second bracket 240 to the LCD cover of the display unit 3. The LCD cover 16 is fastened by the screw passed through the screw through hole 244 in a state where the LCD cover fixing piece 243 is engaged at the screw fastened position.

The first hinge device 21 has a rotation regulating portion for regulating the rotation of the shaft based on a relative displacement between the first bracket 210 and the second bracket 240 on the shaft in the axial direction away from the second bracket 240 received within the display unit 3. The rotation regulating portion is mainly composed of a stopper member 219 and a pin 230a as will be described later, and regulates the rotation of the display unit 3 at a certain angle in the open position. Also, the first hinge device includes a cam mechanism portion for holding the hinge shaft to prevent the display unit 3 from being rotated in the opening direction in the closed position. The cam mechanism portion is mainly composed of a first cam member 215 and a second cam member 216.

Referring to FIGS. 3 to 6, a structure of the first hinge device 21 will be described below in detail.

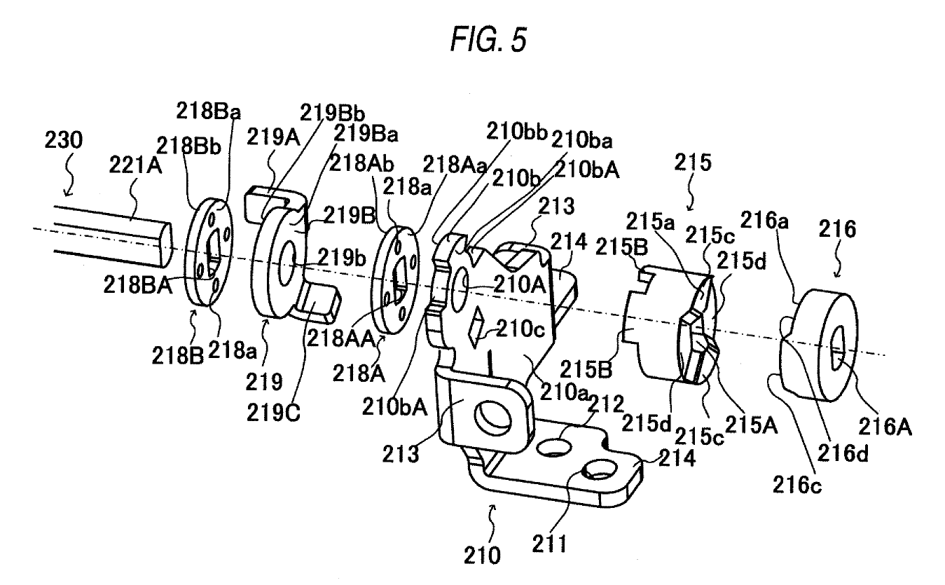

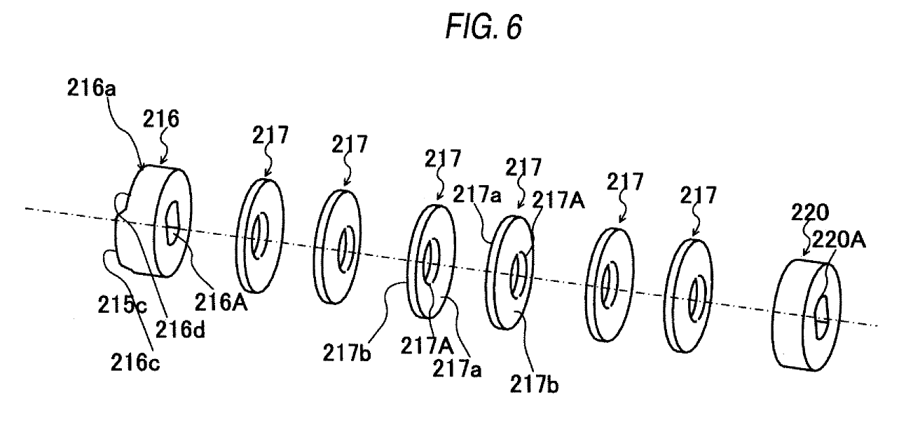

FIGS. 5 and 6 are the exploded views of the hinge device 21. The hinge device 21 has the first bracket 210, the first cam member 15, the second cam member 216, a plurality of disc springs 217, a first and a second friction plates 218A and 218B, the stopper member 219, a fixing plate 220, the hinge shaft 230, and the second bracket 240. In FIGS. 5 and 6, the second bracket 240 is not shown. For the hinge device 21 as shown in FIGS. 5 and 6, the portion except for the disc springs 217 is formed of stainless steel (SUS), and the first cam member 215 and the second cam member 216 are parkerized as a surface treatment to increase wear resistance.

Each element of the first hinge device 21 will be described below.

The first bracket 210 has a bracket main body 210a, base fixing pieces 213 and 214, and a cam fixing piece 210b. The base fixing pieces 213 and 214 are positioned and fastened by screw or the like in the hinge support portion 20a of the base 5. Also, the cam fixing piece 210b has a concave portion 210bA. The first bracket 210 has a circular hole portion 210A having a larger area than the cross section of a first shaft 221A, and attached to the first shaft 221A to be rotatable around the first shaft 221A. Also, the first bracket 210 has a hole portion 210c in the shape of rectangular cross section that is equivalent to the cross section of an engagement piece 219C in the bracket main body 210a.

The first cam member 215 has a cam face 215a at one end of cylindrical shape, and an engagement piece 215B at the other end. The cam face 215a is composed of a convex face 215c and a flat face 215d. The engagement piece 215B is engaged in a concave portion 210bA of the cam fixing piece 210b to regulate the relative rotational motion with the first bracket 210. The cam face 215a of the first cam member 215 and a cam face 216a of the second cam member 216 as will be described later are contacted to fulfill a function of cam. Accordingly, the first cam member 215 fulfills the function of a cam member on the stationary side. The first cam member 215 has a hole portion 215A in the shape of rectangular cross section that is equivalent to the cross section of the shaft 221, and attached to the first shaft 221A to regulate the rotation around the first shaft 221A.

The second cam member 216 has the cam face 216a composed of a convex face 216c and a flat face 216d, and the flat face 216d has the shape engaged with the convex face 215c of the cam face 215a.

The convex face 215c is formed with a smooth curved face at the corner portion. The force of torque can be adjusted by adjusting the angle of this curved face. The second cam member 216 has a hole portion 216A in the shape of rectangular cross section that is equivalent to the cross section of the shaft 221, and is attached to the first shaft 221A to regulate the rotation around the first shaft 221A.

The disc springs 217 apply an elastic force to the second cam member 216. The disc springs 217 are formed of high tensile steel to have the cross section like a gentle curve, and attached to the shaft 221 so that the concave faces 217a of two disc springs 217 may be confronted and combined to form a pair. Each disc spring 217 has a circular hole portion 217A having a larger area than the cross section of the first shaft 221A, and is attached to the first shaft 221A to be rotatable around the first shaft 221A. One pair of disc springs 217 are deformed according to an external force to cause a resiliency, if the external force is applied in a direction compressing the convex face 217b. In this embodiment, three pairs of disc springs 217 are employed.

The first friction plate 218A is a flat plate having a circular cross section, and in the center has a hole portion 218AA in the shape of rectangular cross section that is equivalent to the cross section of the first shaft 221A, and is attached to the first shaft 221A to regulate the rotation around the shaft 221. The first friction plate 218A has a hole portion 218a for supplying grease to a contact surface between the stopper member 219 and the first bracket 210. The contact surface is supplied with a proper amount of oil owing to grease supplied through the hole portion 218a to suppress the increasing sliding resistance. The first friction plate 218A is provided between the stopper member 219 and the first bracket 210 through the shaft 221.

The stopper member 219 has a stopper 219A, a stopper main body 219B and an engagement piece 219C. The engagement piece 219C is inserted into an engagement hole portion 210c provided in the bracket main body 210a of the first bracket 210. Thereby, the stopper main body 219B confronts and contacts the first friction plate 218A. The stopper main body 219B has a circular hole portion 219b having a larger area than the cross section of the first shaft 221A, and is attached to the first shaft 221A to be rotatable around the first shaft 221A. The stopper member 219 is located on the outer periphery of the second friction plate 218B by folding the stopper 219A. The stopper 219A is regulated from being rotated because the pin 230a (FIG. 3) of the hinge shaft 230 contacts the side face of the stopper 219A with the rotation based on a relative displacement around the hinge shaft 230 between the first bracket 210 and the second bracket 240.

The second friction plate 218B has the same shape as the first friction plate 218A. The second friction plate 218B is provided between the stopper member 219 and a first flange member 231A as will be described later.

Thereby, a frictional force occurs on the friction face not only between the first cam member 215 and the second cam member 216, but also between the second friction plate 218B and the stopper member 219, between the stopper member 219 and the stopper 219A, and between the first friction plate 218A and the first bracket 210. Accordingly, a larger torque can be produced than only between the first cam member 215 and the second cam member 216.

The fixing plate 220, which has a columnar shape, in the center has a hole portion 220A in the shape of rectangular cross section that is equivalent to the cross section of the first shaft 221A, and is attached to the first shaft 221A to regulate the rotation around the shaft 221. The fixing plate 220 is fixed with a fixing portion 222 configured of caulking with the first shaft 221A passing through the hole portion 220A.

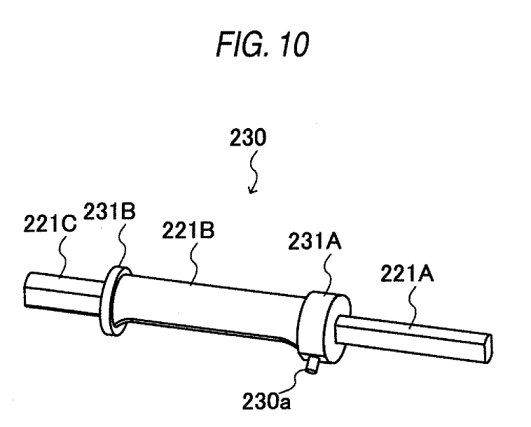

FIG. 10 is a view showing the hinge shaft 230. The hinge shaft 230 has a first shaft 221A, a second shaft 221B and a third shaft 221C, as shown in FIG. 10.

The first shaft 221A has the shape of rectangular cross section, and supports coaxially the second friction plate 218B, the stopper member 219, the first friction plate 218A, the first bracket 210, the first cam member 215, the second cam member 216, the disc springs 217 and the fixing plate 220.

The second shaft 221B has a larger cross section than the first shaft 221A, and is like a crank as a whole.

The third shaft 221C has the shape of rectangular cross section one size larger than the first shaft 221A. The third shaft 221C securely supports the second bracket 240.

The first flange 231A is provided between the first shaft 221A and the second shaft 221B. The first flange 231A receives the second friction plate 218B. Also, the pin 230a is provided on the side face of the first flange 231A.

A second flange 231B is provided between the second shaft 221B and the third shaft 221C. The second flange 231B receives the second bracket 240 securely supported on the third shaft 221C. The first shaft 221A, the first flange 231A, the second shaft 221B, the second flange 231B and the third shaft 221C are integrally formed.

(Increasing Torque)

The cam mechanism portion of the hinge device 21 is configured between the first cam member 215 and the second cam member 216, as previously described. This cam mechanism portion holds the first bracket 210 and the second bracket 240 at a certain angle based on a face contact between the cam face 215a of the first cam member 215 and the cam face 216a of the second cam member 216. FIGS. 3 and 4 show the state where the cam face 215a and the cam face 216a are engaged together by convex and concave.

The first shaft 221A rotatably supports the stopper 219A, the first bracket 210, the disc springs 217, and the first cam member 215. Also, the first shaft 221A supports the first friction plate 218A, the second friction plate 218B, the second cam member 216, and the fixing plate 220 slidably in the axial direction.

With the first hinge device 21 configured as the above, a larger torque can be produced than the torque amount only between the first cam member 215 and the second cam member 216. That is, in this embodiment, the first friction plate 218A and the second friction plate 218B are provided on both sides of the stopper member 219. Thereby, a frictional force occurs on the friction face not only between the first cam member 215 and the second cam member 216, but also between the second friction plate 218B and the stopper member 219, between the stopper member 219 and the stopper 219A, and between the first friction plate 218A and the first bracket 210.

More specifically, if an operation of closing the display unit 3 on the main body unit 2 or opening the display unit 3 (rotation operation) is performed, the second bracket 240 fixed to the LCD cover 16 in a part of the display unit 3 is also rotated. Since the second bracket 240 is securely supported by the hinge shaft 230, the first shaft 221A in a part of the hinge shaft 230 is rotated with respect to the first bracket 210.

Herein, the stopper member 219 is not rotated with respect to the first bracket 210, because the engagement piece 219C is engaged in the engagement hole portion 210c. However, the first friction plate 218A and the second friction plate 218B are rotated along with the rotation of the first shaft 221A, because the hole portion 218AA and the hole portion 218BA have the same shape as the cross-sectional shape of the first shaft 221A. That is, frictional resistance occurs between the face 218Ba and the face 219Bb.

Similarly, frictional resistance occurs between the face 219Ba and the face 218Ab, and between the face 218Aa and the face 210bb.

Accordingly, the first hinge device 21 has not only the torque in the cam mechanism between the first cam member 215 and the second cam member 216, but also frictional resistance in other three portions, increasing the torque of the first hinge device 21 as a whole.

Accordingly, when the display unit 3 has a larger size, it is possible to produce a desired torque suitable for the display unit 3 by applying the hinge device of this embodiment.

### Operation of this Embodiment

In the portable computer 1 of this configuration, the operation of the hinge device 21 in opening the display unit 3 with respect to the main body unit 2 from the closed state will be described below.

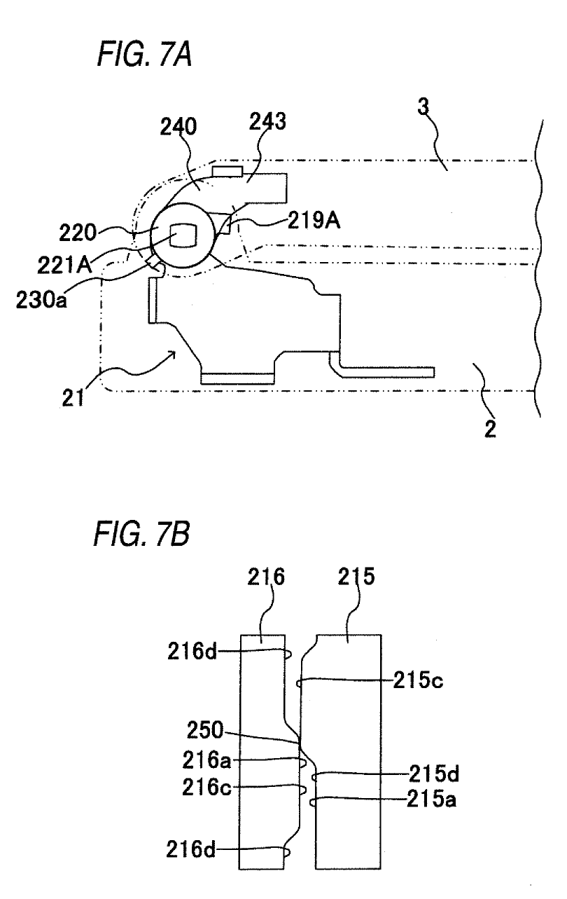

FIGS. 7A and 7B show a state where the display unit 3 is closed on the main body unit 2, in which FIG. 7A is a schematic view showing the state of the hinge device, the display unit and the main body unit, and FIG. 7B is a schematic view showing the state of the cam mechanism portion for the hinge device in FIG. 7A. For the cam mechanism portion of FIG. 7B, the schematic view shows the first cam member 215 and the second cam member 216 for the hinge device 21 as seen in the horizontal direction from the side of the keyboard.

When the display unit 3 is closed on the main body unit 2, the angle made by the display unit 3 and the main body unit 2 with the shaft 221 as the rotation axis is about 0°, as shown in FIG. 7A. At this time, the cam face 215a of the first cam member 215 and the cam face 216a of the second cam member 216 are partially contacted, as shown in FIG. 7B.

In the state as shown in FIG. 7B, a torque occurs in the direction urging the convex and concave engagement with the flat face 216d (the direction closing the display unit 3), owing to the shape of gentle curved face on the corner portion of the convex face 215c.

Thereby, since the torque in the closing direction with the first shaft 221A as the rotation axis is applied to the display unit 3, the display unit 3 is not opened inadvertently. Though the angle (inclination of the display unit 3) when the convex face 215c and the flat face 216d are engaged by convex and concave is set at −15° in this embodiment, the torque in the closing direction occurs on the first shaft 221A under the action of the cam mechanism portion if the inclination of the display unit 3 is 5 mainly or less.

In this embodiment, the first friction plate 218A and the second friction plate 218B are provided on both faces of the stopper member 219. Thereby, a frictional force occurs on the friction face not only between the first cam member 215 and the second cam member 216, but also between the second friction plate 218B and the stopper member 219, between the stopper member 219 and the stopper 219A, and between the first friction plate 218A and the first bracket 210. Accordingly, a larger torque can be produced than only between the first cam member 215 and the second cam member 216. Accordingly, when the display unit 3 has a larger size, a desired torque can be produced by applying the hinge device of this embodiment.

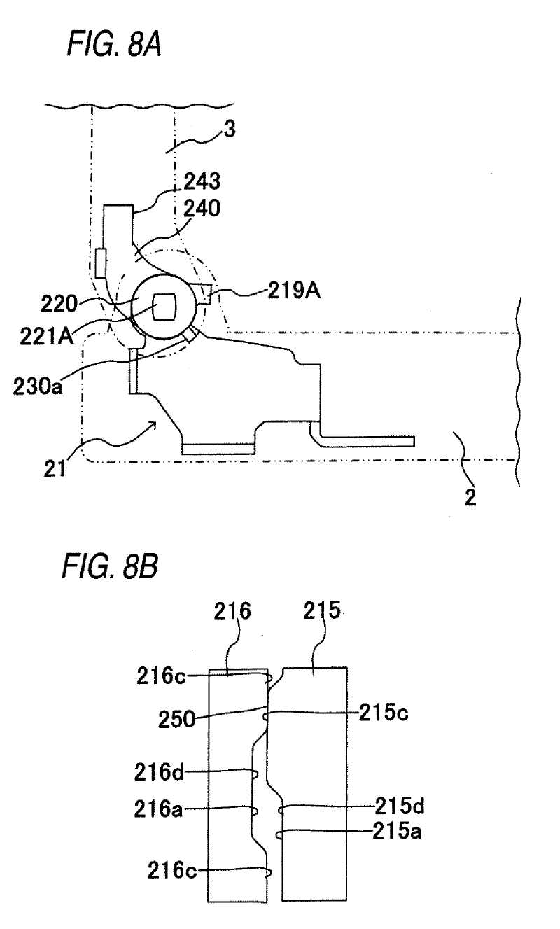

FIGS. 8A and 8B show a state where the display unit 3 is opened up to 90° with respect to the main body unit 2, wherein FIG. 8A is a schematic view showing the state of the hinge device, the display unit and the main body unit, and FIG. 8B is a schematic view showing the state of the cam mechanism portion for the hinge device in FIG. 8A.

When the display unit 3 is opened up to 90° with respect to the main body unit 2 as shown in FIG. 8A, a contact portion 250 between the convex face 215c and the convex face 216c has a larger area than in FIGS. 7A and 7B, so that the face contact resistance is smaller than in FIGS. 7A and 7B, as shown in FIGS. 8A and 8B. Thereby, the display unit 3 can be rotated around the shaft 221 as the rotation axis with a smaller external force.

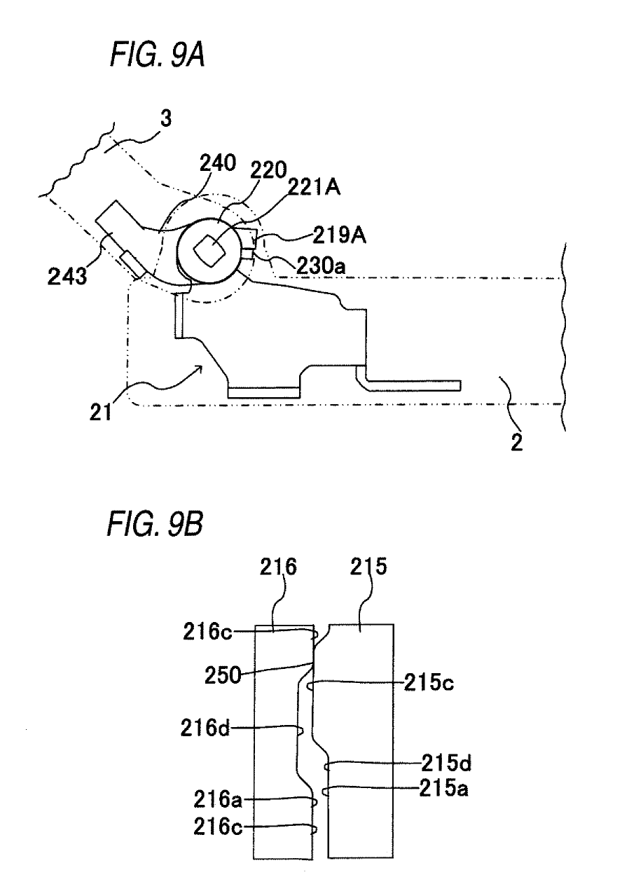

FIGS. 9A and 9B show a state where the display unit 3 is opened up to 135° with respect to the main body unit 2, in which FIG. 9A is a schematic view showing the state of the hinge device, the display unit and the main body unit, and FIG. 9B is a schematic view showing the state of the cam mechanism portion for the hinge device in FIG. 9A.

When the display unit 3 is opened up to 135° with respect to the main body unit 2 as shown in FIG. 9A, the stopper 219A provided in the stopper member 219 contacts the pin 230a provided in the first flange 231A of the hinge shaft 230. Thereby, the rotation of the shaft 221 is regulated, so that the angle of the display unit 3 is kept at 135°.

What is claimed is:

1. A hinge device comprising:
a first bracket;
a first cam member having a first cam face at one side, wherein the other side engages with the first bracket;
a second cam member having a second cam face at one side, the second cam face provided correspondingly to the first cam face;
a disc spring that urges the second cam member on the other side thereof, which is opposite to the second cam face;
a first friction plate provided correspondingly to the first bracket, the first friction plate disposed oppositely to the first cam member with respect to the first bracket;
a stopper member provided correspondingly to the first friction plate on one side thereof, the stopper member disposed oppositely to the first bracket with respect to the first friction plate, the stopper member engaged with the first bracket; and
a hinge shaft having a shaft that rotatably supports the first bracket, the first cam member, the disc spring, and the stopper member, and that unrotatably supports the second cam member and the first friction plate.

2. The hinge device according to claim 1, further comprising a second friction plate provided correspondingly to the stopper member, the second friction plate provided oppositely to the first friction member with respect to the stopper member.

3. The hinge device according to claim 2, wherein the hinge shaft has a first flange portion for receiving the second friction plate.

4. The hinge device according to claim 2, further comprising a stationary portion fixed to the shaft, the stationary portion provided correspondingly to the disc spring, the stationary portion provided oppositely to the second cam member with respect to the disc spring.

5. The hinge device according to claim 3, wherein the first bracket has a fixing piece to be fixed with an electronic apparatus.

6. The hinge device according to claim 4, further comprising a second bracket fixed to the hinge shaft and to be fixed with the electronic apparatus,
wherein the electronic apparatus has a first casing and a second casing,
wherein the first bracket is to be fixed with the first casing and the second bracket is to be fixed with the second casing.

7. The hinge device according to claim 1, wherein the disc spring includes a plurality of disc spring portions.

8. An electronic apparatus comprising:
a first casing;
a second casing;
a hinge device connecting the first casing and the second casing, the hinge device comprising:
a first bracket;
a first cam member having a first cam face at one side, wherein the other side engages with the first bracket;
a second cam member having a second cam face at one side, the second cam face provided correspondingly to the first cam face;
a disc spring that urges the second cam member on the other side thereof, which is opposite to the second cam face;
a first friction plate provided correspondingly to the first bracket, the first friction plate disposed oppositely to the first cam member with respect to the first bracket;
a stopper member provided correspondingly to the first friction plate on one side thereof, the stopper member disposed oppositely to the first bracket with respect to the first friction plate, the stopper member engaged with the first bracket; and
a hinge shaft having a shaft that rotatably supports the first bracket, the first cam member, the disc spring, and the stopper member, and that unrotatably supports the second cam member and the first friction plate.

9. The electronic apparatus according to claim 8, wherein the disc spring includes a plurality of disc spring portions.
